(19) United States
(12) Patent Application Publication
(10) Pub. No.: US 2023/0394477 A1
(43) Pub. Date: Dec. 7, 2023

(54) TRANSACTION PROCESSING SYSTEM, TRANSACTION PROCESSING APPARATUS, AND INFORMATION PROCESSING METHOD

(71) Applicant: Toshiba Tec Kabushiki Kaisha, Tokyo (JP)

(72) Inventors: Mayuko TSUNODA, Yokohama Kanagawa (JP); Yumiko OKUMA, Koganei Tokyo (JP); Hikaru KOMIYAMA, Yokohama Kanagawa (JP)

(21) Appl. No.: 18/183,884

(22) Filed: Mar. 14, 2023

(30) Foreign Application Priority Data
Jun. 6, 2022 (JP) 2022-091719

(51) Int. Cl. G06Q 20/38; G06Q 20/32; G06Q 20/20

(52) U.S. Cl. CPC G06Q 20/387; G06Q 20/3223; G06Q 20/20

(57) ABSTRACT

A transaction processing system according to an embodiment incorporates a communication network and a transaction processing apparatus, such as a server device or the like. The transaction processing apparatus includes a processor configured to receive commodity identifying information from a mobile user terminal for a commodity being registered by a customer in a customer transaction, register the commodity in the customer transaction, identify an applicable coupon associated with the registered commodity in coupons associated with the customer in a user database, cause the mobile user terminal to display a notification screen for notifying the customer of an applicable coupon, and then receive a response from the mobile user terminal designating the identified applicable coupon for use in the customer transaction.

### CROSS-REFERENCE TO RELATED APPLICATION

This application is based upon and claims the benefit of priority from Japanese Patent Application No. 2022-091719, filed Jun. 6, 2022, the entire contents of which are incorporated herein by reference.

### FIELD

Embodiments described herein relate generally to transaction processing systems, transaction processing apparatuses, and information processing methods related to handling of retail merchandise transactions or the like.

### BACKGROUND

A system that performs transaction processing by using an information communication terminal owned by a user, such as a smartphone or tablet computer, is known as a “smartphone POS system”. In some cases, the smartphone or tablet computer may be lent to the user by the store implementing the system. In other examples, a system that performs transaction processing may incorporate an information communication terminal attached to a shopping cart provided by the store. Such a cart-based system is known as a “cart POS system”.

In some instances, coupons may be distributed from a store or the like to a user. Some coupons can be used only for purchasing a specific item (commodity). For example, a coupon may provide a fixed amount discount from a normal sales price of a commodity being purchased.

In a smartphone POS system or a cart POS system described above, it is generally necessary for the user to confirm applicability of the coupon to be applied to a transaction and then perform an operation of declaring the use of the applicable coupon, which is troublesome for the user.

In view of such circumstances, it has been desired that coupons can be more easily used by customers so as to promote sales and improve customer satisfaction.

### BRIEF DESCRIPTION OF THE DRAWINGS

FIG. 1 is a block diagram illustrating a schematic configuration of a transaction processing system according to an embodiment.

FIGS. 2 to 4 are flowcharts related to a registration processing.

FIG. 5 is a diagram illustrating an example of a registration screen.

FIG. 6 is a diagram illustrating an example of a scan screen.

FIG. 7 is a diagram illustrating an example of a first notification screen.

FIG. 8 is a diagram illustrating an example of a second notification screen.

FIG. 9 is a diagram illustrating an example of a registration screen.

FIG. 10 is a diagram illustrating another example of a registration screen.

FIG. 11 is a diagram illustrating an example of a list screen.

FIG. 12 is a diagram illustrating an example of a first change screen.

FIG. 13 is a diagram illustrating an example of a second change screen.

FIG. 14 is a diagram illustrating another example of a registration screen.

FIG. 15 is a diagram illustrating another example of a registration screen.

### DETAILED DESCRIPTION

In general, embodiments concern technological improvements to a transaction processing system, a transaction processing apparatus, and/or an information processing method enabling easy use of a coupon.

According to an embodiment, a transaction processing system includes a communication network connectable to a mobile customer terminal and a transaction processing apparatus including a processor. The processor is configured to receive commodity identifying information from the mobile user terminal for a commodity being registered by a customer in a customer transaction using the mobile user terminal; register the commodity corresponding to the received commodity identifying information in the customer transaction; identify an applicable coupon associated with the registered commodity from coupons associated with the customer in a user database; cause the mobile user terminal to display a notification screen for notifying the customer of an identified applicable coupon after the applicable coupon is identified; and receive a response from the mobile user terminal designating the identified applicable coupon for use in the customer transaction.

In another embodiment, a transaction processing system includes a determination unit, a registration unit, a selection unit, a first display unit, and a determination unit. The determination unit determines a commodity in accordance with an operation performed on a terminal device by a user. The registration unit registers the commodity as a commodity that is a target of the transaction (for purchase). The selection unit selects a coupon from coupons held/possessed by the user. The first display unit causes the terminal device to display, after a coupon is selected by the selection unit, a notification screen for notifying the user of the selected coupon. The determination unit then determines whether the coupon selected by the selection unit is to be applied to the transaction according a response provided by the user via the user terminal.

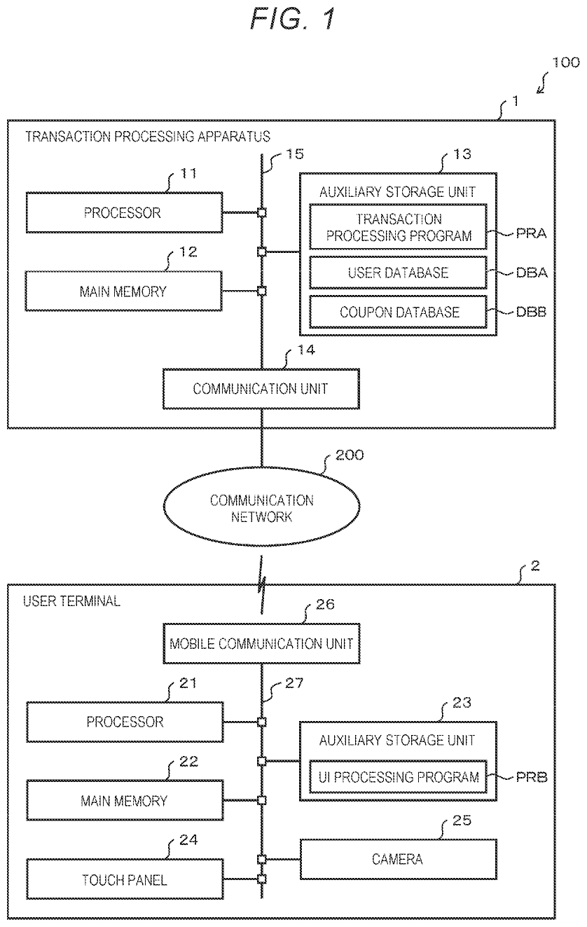

Hereinafter, certain example embodiments will be described with reference to the drawings. FIG. 1 is a block diagram illustrating a schematic configuration of a transaction processing system 100 according to the present embodiment. FIG. 1 also depicts configuration of devices constituting the transaction processing system 100.

In the transaction processing system 100, a transaction processing apparatus 1 and a user terminal 2 are able to communicate with each other via a communication network 200. Any number of transaction processing apparatuses 1 and user terminals 2 may be provided in the transaction processing system 100, but, for depictional convenience, only one transaction processing apparatus 1 and one user terminal 2 are shown in FIG. 1.

The transaction processing apparatus 1 performs an information processing for processing a commodity trade (sale) transaction between a user and a store in accordance with an operation performed by the user in the store using the user terminal 2 as a user interface terminal. The transaction processing apparatus 1 is implemented as, for example, a cloud server, and processes transactions in a plurality of separate stores. In some examples, transaction processing apparatus 1 may be implemented as a local server and process transactions in only one store.

The user terminal 2 is an information processing terminal carried by a user (a mobile terminal). The user terminal 2 is typically owned by the user and is brought into a store by the user. In some examples, the user terminal 2 may be an information communication terminal lent from a store to a user, an information communication terminal attached to a shopping cart provided as equipment in the store, or the like. The user terminal 2 is a terminal device that receives an input operation performed by a user related to a transaction to be processed (transaction processed) in the transaction processing apparatus 1.

As the communication network 200, the Internet, a virtual private network (VPN), a LAN, a public communication network, a mobile communication network, or the like can be used separately or in combination as appropriate. For example, the Internet and a mobile communication network are used in combination as the communication network 200.

The transaction processing apparatus 1 includes a processor 11, a main memory 12, an auxiliary storage unit 13, a communication unit 14, a transmission path 15, and the like. The processor 11, the main memory 12, the auxiliary storage unit 13, and the communication unit 14 can communicate with one another via the transmission path 15.

The processor 11, the main memory 12, and the auxiliary storage unit 13 are connected to one another through the transmission path 15 to constitute a computer that performs an information processing for controlling the transaction processing apparatus 1.

The processor 11 executes information processing for controlling each unit to implement the various functions of the transaction processing apparatus 1 in accordance with an operating system and/or an information processing program such as an application program (an “app”).

The main memory 12 includes a read-only memory area and a rewritable memory area. The main memory 12 stores a part of the information processing program in the read-only memory area. In addition, the main memory 12 may store, in the read-only memory area or the rewritable memory area, data necessary for the processor 11 to execute the processing for controlling each unit. The rewritable memory area of the main memory 12 is used as a work area for the processor 11.

As the auxiliary storage unit 13, an electric erasable programmable read-only memory (EEPROM), a hard disk drive (HDD), a solid-state drive (SSD), or various other well-known storage devices can be used. The auxiliary storage unit 13 stores data used for the processor 11 to perform various types of processing and data generated by the processing in the processor 11. The auxiliary storage unit 13 may store the information processing program executed by the processor 11. In the present embodiment, the auxiliary storage unit 13 stores a transaction processing program PRA. The transaction processing program PRA is an application program in which a procedure of the transaction processing including a registration processing is programmed. A part of a storage area of the auxiliary storage unit 13 is used as an area for storing a user database DBA and a coupon database DBB. The user database DBA is a database for managing users of a smartphone POS service. The user database DBA includes data for managing (tracking) coupons possessed by the users of the smartphone POS service. The coupon database DBB is a database for managing (tracking) the coupons that can be used in a store where the smartphone POS service is provided. The coupon database DBB includes, for each of a plurality of coupons, data indicating application conditions for the coupon (e.g., use conditions/restrictions), the privilege to be provided (e.g., the discount amount), and the like.

The communication unit 14 executes communication processing for performing data communication via the communication network 200. As the communication unit 14, for example, an existing communication device for the Internet can be used.

The transmission path 15 includes an address bus, a data bus, a control signal line, and the like, and transmits data and control signals exchanged between the connected units.

The transaction processing apparatus 1 can be, for example, a general-purpose server device executing a specific/specialized software program (e.g., transaction processing program PRA). The hardware of transaction processing apparatus 1 can be transferred to an end user with the transaction processing program PRA already stored in the auxiliary storage unit 13 (though typically the user database DBA and the coupon database DBB are not yet stored in the auxiliary storage unit 13 at this point). In other examples, transaction processing program PRA can be transferred separately from the hardware of the transaction processing apparatus 1 and later combined. In some examples, an application program similar to transaction processing application PRA (e.g., an earlier version or variant) and the transaction application PRA may be provided by updating this this earlier version or the like by download or separate installation. Transfer of the transaction processing program PRA can be performed by recording the transaction processing program PRA in a removable recording medium such as a magnetic disk, a magneto-optical disk, an optical disk, or a semiconductor memory, or by communication via a network.

The user terminal 2 includes a processor 21, a main memory 22, an auxiliary storage unit 23, a touch panel 24, a camera 25, a mobile communication unit 26, a transmission path 27, and the like. The processor 21, the main memory 22, the auxiliary storage unit 23, the touch panel 24, the camera 25, and the mobile communication unit 26 can communicate with one another via the transmission path 27. The processor 21, the main memory 22, and the auxiliary storage unit 23 are connected by the transmission path 27.

The processor 21, the main memory 22, the auxiliary storage unit 23, and the transmission path 27 are, in general, similar to the processor 11, the main memory 12, the auxiliary storage unit 13, and the transmission path 15, and thus additional description thereof will be omitted. The auxiliary storage unit 23 stores a user interface (UI) processing program PRB rather than the transaction processing program PRA. The UI processing program PRB is an application program in which a procedure of an information processing of the processor 21 for causing the user terminal 2 to operate as a user interface for the transaction processing of the transaction processing apparatus 1 is programmed.

The touch panel 24 functions as an input device and a display device of the user terminal 2. The camera 25 includes an optical system and an image sensor, and the image sensor generates image data representing an image in a field of view formed by the optical system.

The mobile communication unit 26 is an interface for data communication via the communication network 200. As the mobile communication unit 26, for example, a well-known communication device for performing data communication via a mobile communication network may be used.

The transmission path 27 includes an address bus, a data bus, a control signal line, and the like, and transmits data and control signals exchanged between the connected units.

Next, an operation of the transaction processing system 100 will be described. Specific content of the processing to be described below is merely an example, and changes of the order of processing, omissions of some processing, additions of processing, and the like are possible. In general, the described processing aspects in the present example concern features relevant for understanding operations distinctive to the present embodiment as compared to the related art. For example, when an error occurs, standard or conventional processing for coping with such an error may be performed, and thus particular description of such processing is omitted, but can still be assumed as present in operational embodiments of the present disclosure.

As will be described below, a service provided to a user by the transaction processing system 100 is a smartphone POS (point-of-sale) service. When an information communication terminal attached to a cart is used as the user terminal 2, the service may be referred to as a cart POS service.

A provider, who provides a coupon to a user of the smartphone POS service, may access the transaction processing apparatus 1 by using an external information terminal. The coupon provider designates various types of information related to the coupon to be provided. In response to this external input, the processor 11 updates the coupon database DBB.

The various types of information related to the coupon is, for example, a coupon identifier (coupon ID code), a coupon name (descriptive text), a use period (valid dates), the available number of times the coupon can be used, an application condition (use conditions/restrictions), and an associated coupon privilege (customer benefit associated with the use of the coupon). For example, it can be assumed that the application condition is such things as “3 items of a commodity having a commodity code of 1234567890123 to be transaction targets”, “both a commodity having a commodity code of 123456789023 and a commodity having a commodity code of 1111222233334 to be transaction targets”, “the first one hundred arrivals”, “1 item of any commodity to be a transaction target”, or the like. In addition, it is assumed that the coupon privilege can be defined as such things as “a 100-yen discount on a target commodity”, “a 10% discount from the total transaction amount”, or the like. However, what type of information is included in the various types of information on the coupon may be freely determined by, for example, a designer of the transaction processing apparatus 1. Contents of the various types of information on the coupon may be freely determined by the provider of the coupon or the like.

In order to use the smartphone POS service, a user performs user registration in accordance with a provider of the smartphone POS service. With this user registration, an identifier for uniquely identifying the user (hereinafter, referred to as a user code) is set, and the user database DBA is updated so that various types of user information necessary for the user to use the smartphone POS service is expressed in association with the user code. The user information may also include a coupon identifier of a coupon that has been acquired by the user. In order to use the smartphone POS service, the user installs the UI processing program PRB in a smartphone or the like owned by the user so that the smartphone or the like can be used as the user terminal 2. With the UI processing program PRB activated, the user enters a store to which the smartphone POS service is provided.

The user operates the user terminal 2 to perform a predetermined check-in processing to be performed between the user terminal 2 and the transaction processing apparatus 1. Then, when the check-in is completed, the user selects a commodity as a target of the transaction (hereinafter, referred to as a transaction commodity or item being purchased), and inputs a commodity code of the selected commodity into the user terminal 2.

In the transaction processing apparatus 1, after the processor 11 completes the check-in processing, the processor 11 starts a registration processing. The registration processing is for registering a commodity designated by the user as a transaction commodity (an item to be purchased).

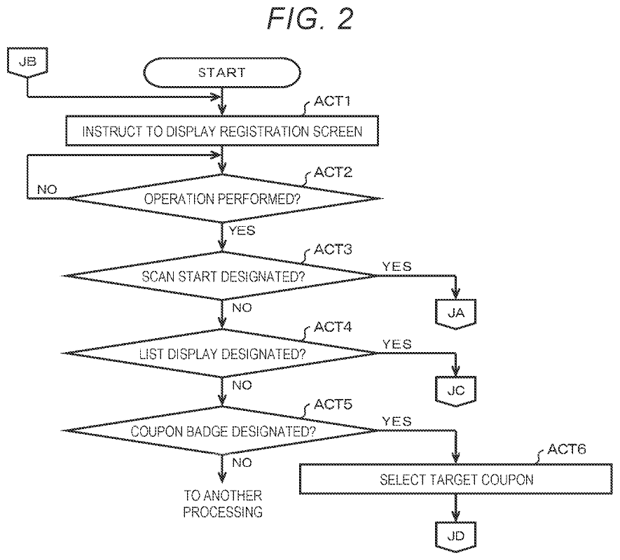

FIGS. 2, 3, and 4 are flowcharts of this registration processing.

As ACT 1 in FIG. 2, the processor 11 instructs the user terminal 2 to display a registration screen. The registration screen includes a list of commodities that have bene registered as transaction commodities, and is a screen for enabling a user to recognize the registration state of the transaction commodities. For example, the processor 11 generates screen data representing a registration screen reflecting the registration state of the transaction commodities, and transmits instruction data for instructing the user terminal 2 to perform screen display based on the screen data from the communication unit 14 to the user terminal 2 via the communication network 200.

After the instruction data for the screen display is transmitted to the user terminal 2 via the communication network 200, the mobile communication unit 26 of the user terminal 2 receives the instruction data. Once the instruction data is received, the mobile communication unit 26 notifies the processor 21 of the reception of the screen display instruction data. The processor 21 (executing the UI processing program PRB) then causes the touch panel 24 to display a screen as indicated by the screen data included in the instruction data.

The transmission and reception of display instructions for various the screens to be described below are performed with the same procedure as described above, although contents of screen data may be different.

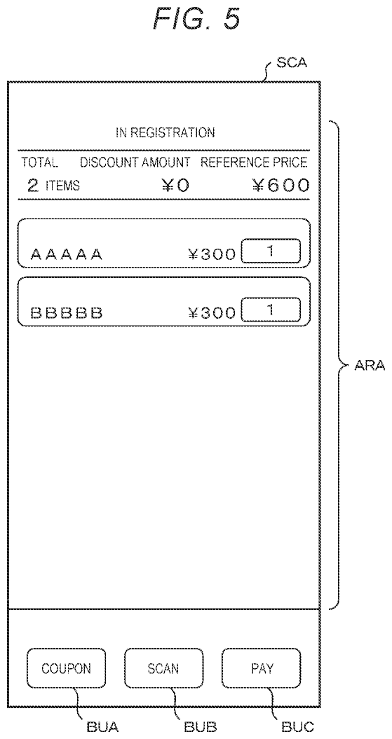

FIG. 5 is a diagram illustrating an example of a registration screen SCA.

On the registration screen SCA, an image indicating a registration state is provided in a display area ARA. The registration screen SCA displays buttons BUA, BUB, and BUC. In the example in FIG. 5, the image provided in the display area ARA indicates a state where a total of 2 items, each having a unit price of 300 yen, are registered with commodity names “AAAAA” and “BBBBB”, and a reference price (transaction subtotal before finalization) thereof is 600 yen. The reference price is a total sum of prices of all transaction commodities with any applicable discount (coupons) subtracted/applied. When proceeding to the settlement without any additional coupon(s) to be applied, the reference price becomes a settlement amount (transaction total). In the example in FIG. 5, the image provided in the display area ARA indicates that the discount amount is presently 0 yen. The image provided in the display area ARA changes successively according to registration of additional transaction commodities. When the processor 11 executes ACT 1 in FIG. 2 for the first time, no transaction commodity has yet been registered. Therefore, on the registration screen indicated by the screen data transmitted to the user terminal 2 when the processor 11 executes ACT 1 in FIG. 2 for the first time, the image provided in the display area ARA is an image that does not indicate any information of commodities but indicates a total of 0 items and a reference price of 0 yen.

The button BUA is a soft key for receiving an instruction to display a list screen of coupons possessed by the user. The button BUB is a soft key for receiving an instruction to shift to scanning of a new commodity. The button BUC is a soft key for receiving an instruction to start payment (e.g., end the registration processes and begin payment/settlement processes). On the registration screen SCA and various screens to be described later, additional images and/or text may be present in some examples.

The processor 21 waits for an operation to be performed on the registration screen SCA by the user on the touch panel 24. When an operation is performed on the registration screen SCA, the processor 21 transmits notification data for notifying operation contents from the mobile communication unit 26 to the transaction processing apparatus 1 via the communication network 200.

When the notification data is transmitted to transaction processing apparatus 1 via the communication network 200, the communication unit 14 of the transaction processing apparatus 1 receives the notification data. After the notification data is received, the communication unit 14 notifies the processor 11 of the reception of the notification data. The notification of operation contents related to various screens to be described below is transmitted and received in the same procedure as described above although operation contents are different.

As ACT 2 in FIG. 2, the processor 11 waits for an operation to be performed on the user terminal 2. Then, once the processor 11 is notified by the communication unit 14 that the notification data for notifying the operation contents has been received, the processor 11 makes a determination of YES indicating that an operation was performed, and proceeds to ACT 3.

As ACT 3, the processor 11 checks whether the performed operation is an operation of designating the start of scanning. If not, the processor 11 makes a determination of NO and proceeds to ACT 4.

As ACT 4, the processor 11 checks whether the performed operation is an operation of designating display of a list screen of coupons. If not the processor 11 makes a determination of NO and proceeds to ACT 5.

As ACT 5, the processor 11 checks whether the performed operation is an operation of designating a coupon badge in the registration screen SCA. If not the processor 11 makes a determination of NO, and confirms operation contents and proceeds to other processing for performing a processing corresponding the performed operation. For example, the processor 11 confirms that an operation of designating the start of payment is performed, calculates a settlement amount as a price of the registered commodities, activates a payment processing for paying the settlement amount, and then ends the registration processing. The processor 11 may check whether an operation of designating a transaction cancellation has been performed and end the registration processing after executing a processing for cancelling the transaction.

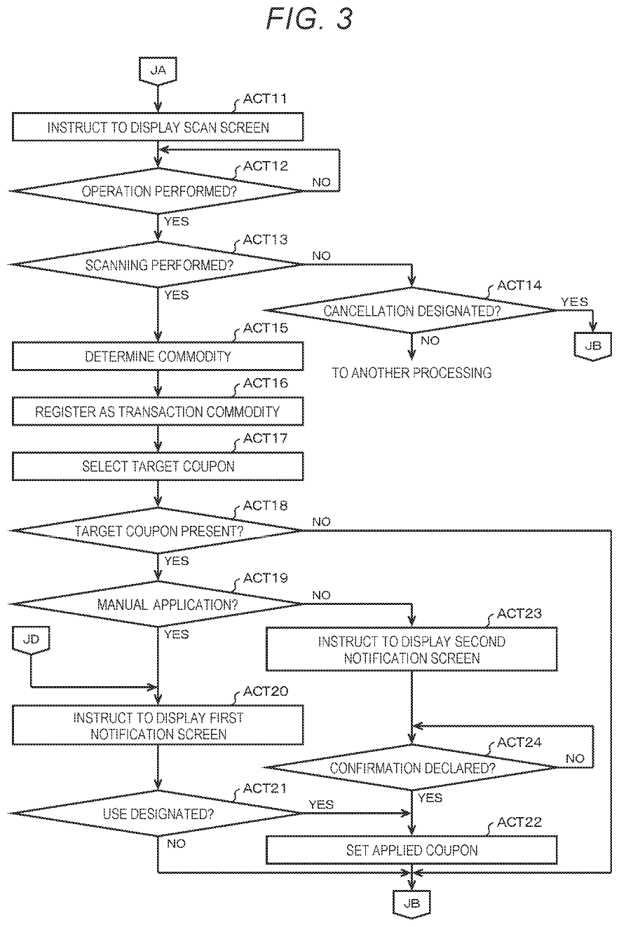

When newly registering a commodity as a transaction commodity, the user performs a predetermined operation for designating the start of scanning, such as tapping the button BUB on the registration screen SCA. When this operation is notified from the user terminal 2 to the transaction processing apparatus 1, the processor 11 makes a determination of YES in ACT 3, and proceeds to ACT 11 in FIG. 3.

As ACT 11, the processor 11 instructs the user terminal 2 to display a scan screen.

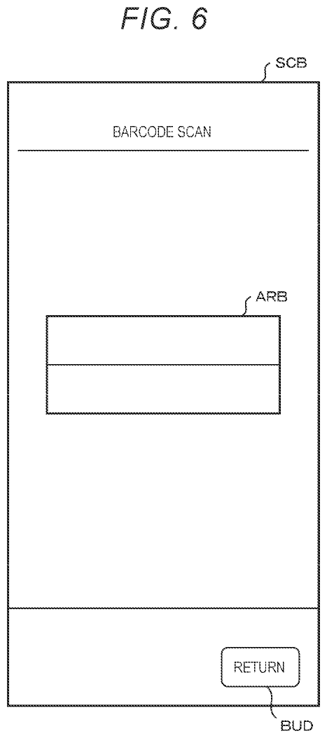

FIG. 6 is a diagram illustrating an example of a scan screen SCB.

The scan screen SCB includes a display area ARB and a button BUD. The display area ARB is an area for displaying an image obtained by the camera 25. The button BUD is a soft key for the user to declare that the scanning of a commodity code is cancelled.

In the user terminal 2, when displaying the scan screen SCB, the processor 21 activates the camera 25, and displays an image obtained by the camera 25 in the display area ARB in a superimposed manner. When an operation related to the scan screen SCB is performed by the user, the processor 21 notifies the transaction processing apparatus 1 of contents of this operation.

In the transaction processing apparatus 1, when the instruction to display the scan screen is completed as ACT 11 in FIG. 3, processor 11 proceeds to ACT 12.

In ACT 12, the processor 11 waits for an input operation to be performed on the user terminal 2. Then, after operation contents are notified from the user terminal 2, the processor 11 makes a determination of YES indicating that an input operation was performed, and proceeds to ACT 13.

As ACT 13, the processor 11 check whether a scanning was performed. If not, the processor 11 makes a determination of NO and proceeds to ACT 14.

As ACT 14, the processor 11 checks whether a cancellation of the scanning was designated. If not, the processor 11 makes a determination of NO, and confirms operation contents and proceeds to other processing for performing a processing corresponding the input operation. For example, the processor 11 checks whether an operation of designating display of a list of coupons was performed, and instructs the user terminal 2 to display a list screen showing a list of all coupons possessed by the user.

When the user desires to return to the registration screen SCA, without performing scanning, the user designates cancellation of the scanning by a predetermined operation such as tapping the button BUD. In this case, the processor 21 notifies the transaction processing apparatus 1 that cancellation has been designated.

In response to the notification, the processor 11 makes a determination of YES in ACT 14, returns to ACT 1 in FIG. 2, and returns the display screen of the touch panel 24 to the registration screen SCA.

When the scan screen SCB is displayed on the touch panel 24, the user directs the camera 25 to a commodity so that a barcode displayed on the commodity to be registered as a transaction commodity is reflected in the display area ARB. The processor 21 analyzes an image obtained by the camera 25 and attempts to read the barcode. When the barcode is read, the processor 21 notifies the transaction processing apparatus 1 that the scanning is performed, and notifies the transaction processing apparatus 1 of data indicated by the read barcode (hereinafter, referred to as barcode data).

In response to the notification performed by the user terminal 2 as described, the processor 11 of the transaction processing apparatus 1 makes a determination of YES in ACT 13 in FIG. 3 and proceeds to ACT 15.

As ACT 15, the processor 11 determines the commodity, which is to be treated as a transaction commodity, based on the notified barcode data. That is, for example, the processor 11 extracts the commodity code included in the barcode data, and determines the commodity, which is identified with the commodity code, as the commodity to be treated as a transaction commodity. In some examples, the processor 11 may receive, from the user terminal 2, a notification about a commodity code directly input as a number sequence, and determine a commodity, which is identified with the commodity code, as the commodity to be treated as a transaction commodity. Thus, when the processor 11 executes the information processing based on the transaction processing program PRA, the processor 11 functions as a determination unit.

As ACT 16, the processor 11 registers the commodity as a transaction commodity. For example, the processor 11 updates transaction data stored in the main memory 12 or the auxiliary storage unit 13 so as to include the commodity code determined in ACT 15. That is, a commodity identified with a commodity code included in the transaction data is a transaction commodity. Thus, when the processor 11 executes the information processing based on the transaction processing program PRA, the processor 11 functions as a registration unit.

As ACT 17, the processor 11 selects one of coupons held by the user of the user terminal 2 as a target coupon. First, the processor 11 determines (identifies) the coupons held by the user of the user terminal 2 based on the information in coupon database DBB. Then, the processor 11 checks whether there is a coupon among appropriate the held coupons whose application condition is satisfied by the commodity registered as a transaction commodity in ACT 16 being included in transaction commodities. If there is only one appropriate coupon, the processor 11 may select this coupon as the target coupon. If there are a plurality of potentially appropriate coupons, the processor 11 selects, as the target coupon, for example, the coupon providing the largest discount amount from among the plurality of coupons. If there is no appropriate coupon, the processor 11 does not select a target coupon. The rule(s) for selecting a target coupon from among multiple potential coupons may be appropriately set by, for example, the designer of transaction processing apparatus 1. When the processor 11 executes the information processing based on the transaction processing program PRA, the processor 11 functions as a selection unit.

As ACT 18, the processor 11 checks whether there is the target coupon that was selected in ACT 17. When a target coupon can be selected in ACT 17, the processor 11 makes a determination of YES, and proceeds to ACT 19.

As ACT 19, the processor 11 checks whether the target coupon is a target for manual application or automatic application. For example, the processor 11 confirms whether the target coupon is a target for manual application or automatic application according to a predetermined rule, based on an application condition of the target coupon or the like. For example, the processor 11 determines that the target coupon is a target for manual application when there is a limit on the number of times the target coupon can be used. Alternatively, for example, when the application condition of the target coupon includes a condition such as “the first one hundred arrivals”, the processor 11 determines that the target coupon is a target of the automatic application. The rule used by the processor 11 for the confirmation may be appropriately set by, for example, the designer of the transaction processing apparatus 1. When it is determined that the target coupon is a target for the manual application, the processor 11 makes a determination of YES and proceeds to ACT 20.

As ACT 20, the processor 11 instructs the user terminal 2 to display a first notification screen.

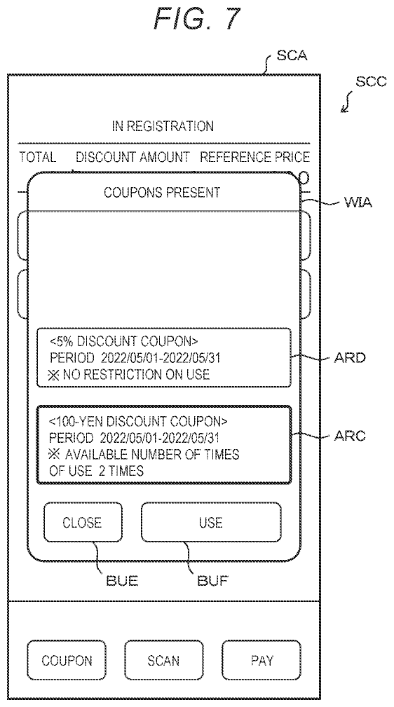

FIG. 7 is a diagram illustrating an example of a first notification screen SCC.

The first notification screen SCC is a screen showing a window WIA superimposed on the registration screen SCA displayed on the user terminal 2 before the scan screen SCB. The window WIA displays, by using a character string in a display area ARC, information for allowing the user to recognize what kind of coupon the target coupon is. In addition, the first notification screen SCC is an example of a case where there are two coupons whose application conditions are satisfied due to the commodity registered as the transaction commodity in ACT 16 being included in the transaction commodities, and displays, by using a character string in a display area ARD, information for causing the user to recognize what kind of coupon among the appropriate coupons is a not a target coupon. In a case where there are three or more coupons whose application conditions are satisfied due to the commodity registered as the transaction commodity in ACT 16 being included in the transaction commodities, another one or a plurality of display areas are added to the upper side of the display area ARD, and information on the respective coupons is displayed. That is, the first notification screen SCC illustrated in FIG. 7 is an example of a case where a first coupon (“100-yen discount coupon”) is selected as the target coupon but a second coupon (“5% discount coupon”) is present additionally. In a case where the coupon whose application condition is satisfied due to the commodity registered as the transaction commodity in ACT 16 being included in the transaction commodities is only the target coupon, the display area ARD is not included in the first notification screen SCC.

In the window WIA, buttons BUE and BUF are displayed. The button BUE is a soft key for receiving designation to end the display of the first notification screen SCC. The button BUF is a soft key for receiving designation to use a selected coupon.

When the target coupon is to be used, the user designates an intention to use the targeted coupon by a predetermined operation such as tapping the button BUF without making any other changes/input. In this case, the processor 21 sets the target coupon as a designated coupon and notifies the transaction processing apparatus 1 that a coupon has been designated for use. When the user intends to use a coupon different from the target coupon, the user taps a display area in which information about the other coupon is displayed and designates an intention to use of the other coupon by tapping the button BUF. For example, when the first notification screen SCC is in the state illustrated in FIG. 7, if the user determines to use the “5% discount coupon”, the user taps the display area ARD and then taps the button BUF. In this case, the processor 21 sets, as the designated coupon, the “5% discount coupon” related to the information displayed in the display area ARD tapped by the use, and notifies the transaction processing apparatus 1 that application of the designated coupon (“5% discount coupon”) has been designated. When a coupon is not to be applied, the user designates an intention for non-use by tapping the button BUE. In this case, processor 21 notifies the transaction processing apparatus 1 that non-use has been designated.

Thus, when the processor 11 executes the information processing based on the transaction processing program PRA, the processor 11 functions as a first display unit.

In the transaction processing apparatus 1, after the instruction to display the first notification screen is completed as ACT 20 in FIG. 3, the processor 11 proceeds to ACT 21.

As ACT 21, the processor 11 checks whether the use of a coupon has been designated. When the processor 11 is notified by the user terminal 2 that the use of a coupon has been designated, the processor 11 makes a determination of YES and proceeds to ACT 22.

As ACT 22, the processor 11 sets the coupon to be applied to the transaction (hereinafter, referred to as an applied coupon). For example, the processor 11 adds a coupon identifier for identifying the designated coupon to the transaction data stored in the main memory 12 or the auxiliary storage unit 13. Accordingly, the processor 11 manages the coupon identified by the coupon identifier included in the transaction data as an applied coupon in the transaction. Thus, when the processor 11 executes the information processing based on the transaction processing program PRA, the processor 11 functions as a coupon determination unit.

On the other hand, when it is determined in ACT 19 that the target coupon is a target for automatic application, the processor 11 makes a determination of NO and proceeds to ACT 23.

As ACT 23, the processor 11 instructs the user terminal 2 to display a second notification screen.

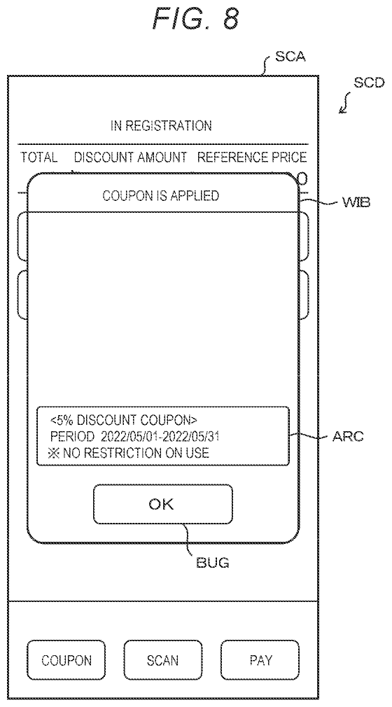

FIG. 8 is a diagram illustrating an example of a second notification screen SCD.

The second notification screen SCD is a screen showing a window WIB superimposed on the registration screen SCA displayed on the user terminal 2 before the scan screen SCB. The window WIB displays, by using a character string in the display area ARC, information for allowing the user to recognize what kind of coupon has been applied to the transaction.

In the window WIB, a button BUG is displayed. The button BUG is a soft key for the user to declare that a notification of the second notification screen SCD is confirmed.

After seeing that the target coupon is to be applied, the user declares this confirmation by tapping the button BUG. In this case, processor 21 notifies the transaction processing apparatus 1 that the confirmation has been declared (indicated).

In the transaction processing apparatus 1, after the instruction to display the second notification screen is completed as ACT 23 in FIG. 3, the processor 11 proceeds to ACT 24.

As ACT 24, the processor 11 waits for the confirmation to be declared. When the processor 11 is notified that the confirmation has been declared, the processor 11 makes a determination of YES and proceeds to ACT 22. As ACT 22, the processor 11 sets the target coupon as the applied coupon.

When ACT 22 is completed, the processor 11 returns to ACT 1 in FIG. 1. When the processor 11 is notified by the user terminal 2 that a non-use was designated by an operation related to the first notification screen SCC as described above, the processor 11 makes a determination of NO in ACT 21 in FIG. 3, and returns to ACT 1 in FIG. 1 without executing ACT 22, that is, without setting a coupon as an applied coupon.

When a target coupon cannot be selected in ACT 17 in FIG. 3, the processor 11 makes a determination of NO in ACT 18, and returns to ACT 1 in FIG. 1 without executing ACT 19 to ACT 24.

When the processing returns from any of ACT 18, ACT 21, and ACT 22 back to ACT 1, the processor 11 causes a new/updated registration screen SCA to display, in the display area ARA, an image indicating the present registration state. That is, the registration screen SCA is updated to reflect any changes in registered items or applied coupons.

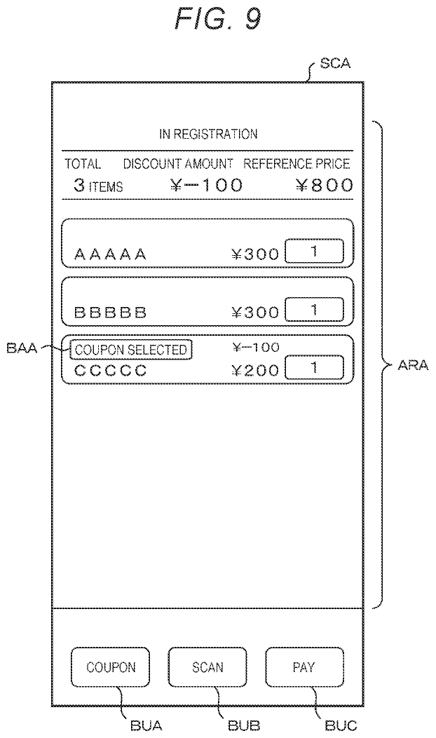

FIG. 9 is a diagram illustrating an example of the registration screen SCA.

The registration screen SCA illustrated in FIG. 9 corresponds to registration screen SCA illustrated in FIG. 5 but another transaction commodity having a commodity name of “CCCCC” and a unit price of 300 yen has been registered. This newly registered item has associated therewith a coupon of a 100-yen discount, and thereafter the processor 11 executes ACT 1 in FIG. 2. In the image displayed in the display area ARA, the commodity name “CCCCC” is added and thus the total number of items, the discount amount, and the reference price are updated. A coupon badge BAA is displayed associated with the commodity name of “CCCCC” in the example of FIG. 9. In this context, a coupon badge is any display object or the like for notifying the user that an applied coupon is set for the associated commodity.

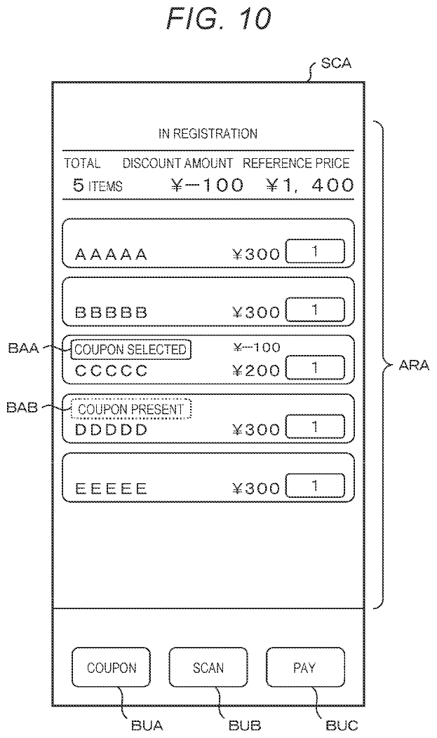

FIG. 10 is a diagram illustrating an example of the registration screen SCA.

The registration screen SCA illustrated in FIG. 10 corresponds to registration screen SCA illustrated in FIG. 9 but a commodity having a commodity name of “DDDDD” and a unit price of 300 yen and a commodity having a commodity name of “EEEEE” and a unit price of 300 yen are additionally registered as transaction commodities, and thereafter the processor 11 executes ACT 1 in FIG. 2. In the image displayed in the display area ARA, information for the commodity name of “DDDDD” and the commodity name of “EEEEE” has been added, and the total number of items, the discount amount, and the reference price have been updated. The example in FIG. 10 is a case where there is a coupon that could be applied to the commodity name of “DDDDD”, but the coupon has not yet been set as an applied coupon. Therefore, a coupon badge BAB for notifying that there is an unapplied coupon is displayed in association with the commodity name of “DDDDD”.

When the user overlooks the potential application of a coupon during the display of the first notification screen SCC or wants to reconsider the application of a coupon again, the user designates a list display by a predetermined operation such as tapping the button BUA in the registration screen SCA. In this case, processor 21 notifies the transaction processing apparatus 1 that the list display has been designated.

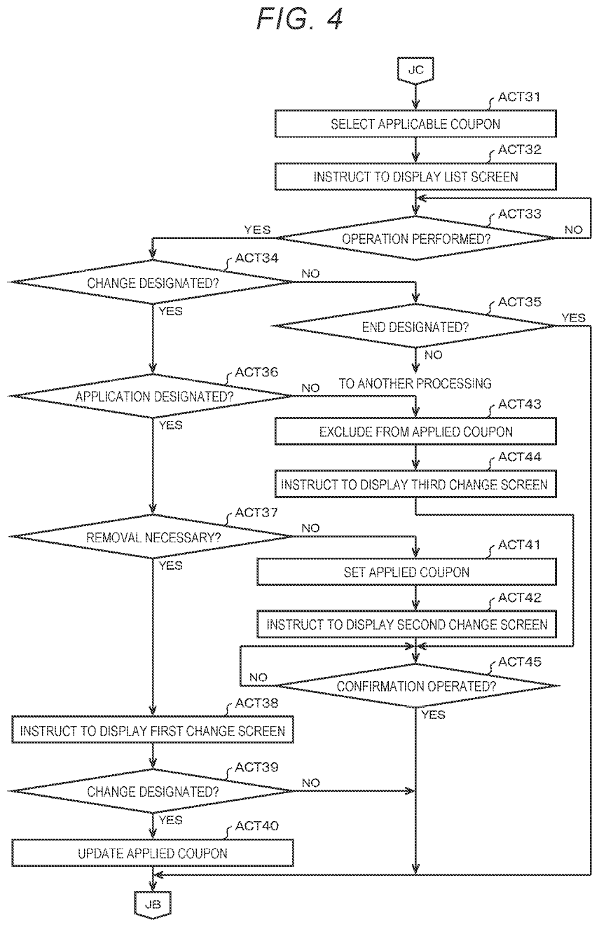

When the transaction processing apparatus 1 receives the notification, the processor 11 is in the waiting state of ACT 2 in FIG. 2. Then, the processor 11 makes a determination of YES in ACT 2, a determination of NO in ACT 3, and a determination of YES in ACT 4, and proceeds to ACT 31 in FIG. 4.

As ACT 31, the processor 11 selects coupons that are applicable in view of the current registration state of transaction commodities (applicable coupons) from all of the coupons held by the user. For example, processor 11 checks the coupons held by the user of the user terminal 2 based on content in the coupon database DBB. Then, the processor 11 confirms whether the application condition(s) for any of the held coupons is satisfied by the current registration state, and when a coupon's application condition is satisfied, the processor 11 identifies that the particular coupon is an applicable coupon. For example, when a coupon requires the purchase of a specific target commodity as an application condition and the specific target commodity is included in the transaction commodities, the processor 11 sets the coupon as an applicable coupon. If a coupon requires the purchase of multiple target commodities as an application condition and each of these target commodities are included in the transaction commodities, the processor 11 sets the coupon as an applicable coupon. If there is no coupon whose application condition is satisfied, the processor 11 does not identify any additionally applicable coupon. Thus, when the processor 11 executes the information processing based on the transaction processing program PRA, the processor 11 functions as a first narrowing-down unit.

As ACT 32, the processor 11 instructs the user terminal 2 to display the list screen.

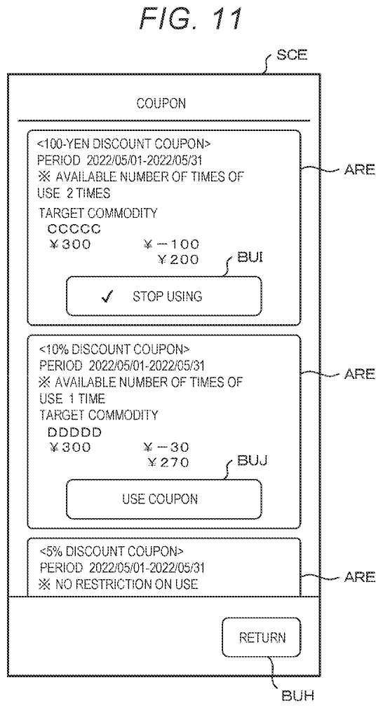

FIG. 11 is a diagram illustrating an example of a list screen SCE.

The list screen SCE displays information on the applicable coupons in individual display areas ARE. The list screen SCE displays a button BUH. The list screen SCE displays a button BUI or a button BUJ in each display area ARE. The button BUI is displayed in the display area ARE in which information on a coupon that is already set as an applicable coupon is shown. The button BUI is a display object for notifying the user that the coupon related to the information shown in the same display area ARE is already set as an applicable coupon. The button BUI is a soft key for the user to designate that the coupon related to the information shown in the same display area ARE is to be excluded from the applicable coupon. The button BUJ is displayed in the display area ARE in which information on a coupon that is not set as an applicable coupon is shown. The button BUJ is a display object for notifying the user that the coupon related to the information shown in the same display area ARE is not set as an applicable coupon. The button BUJ is a soft key for the user to designate that the coupon related to the information shown in the same display area ARE is to be set as an applicable coupon. The button BUH is a soft key for the user to designate an end of the display of the list screen SCE.

Thus, when the processor 11 executes the information processing based on the transaction processing program PRA, the processor 11 functions as a second display unit.

In the user terminal 2, the processor 21 causes the touch panel 24 to display the list screen SCE in response to the above instruction. When an input operation related to the list screen SCE is performed by the user, the processor 21 notifies the transaction processing apparatus 1 of contents of the input operation.

In the transaction processing apparatus 1, when the instruction to display the list screen is completed as ACT 32 in FIG. 4, the processor 11 proceeds to ACT 33.

As ACT 33, the processor 11 waits for an operation to be performed on the user terminal 2. Then, for example, when operation contents are notified from the user terminal 2, the processor 11 makes a determination of YES indicating that an operation is performed, and proceeds to ACT 34.

As ACT 34, the processor 11 checks whether designation of a change related to the coupon application was notified. If not, the processor 11 makes a determination of NO and proceeds to ACT 35.

As ACT 35, the processor 11 checks whether an end of the display of the list screen SCE was designated.

When the user desires to end the display of the list screen SCE and return to the registration screen SCA, the user designates the end of the display by a predetermined operation such as tapping the button BUH. In response to this, the processor 21 notifies the transaction processing apparatus 1 that the end of the display has been designated. When this notification is received, the processor 11 makes a determination of YES in ACT 35 in FIG. 4, returns to ACT 1 in FIG. 2, and returns the display screen of the touch panel 24 to the registration screen SCA.

When the notification from the user terminal 2 is not the end of the display, the processor 11 makes a determination of NO in ACT 35, checks the contents of the operation, and proceeds to other processing for performing a processing corresponding to the received notification. For example, the processor 11 checks whether an operation of designating a change in a narrowing-down condition related to the coupons displayed in the list screen SCE has been performed, and updates the list screen SCE after receiving designation of a new narrowing-down condition.

When the user wants to change use/non-use of any of the applicable coupons displayed in the list screen SCE, the user taps the button BUI or the button BUJ displayed in the display area ARE in which information on the applicable coupon is shown. That is, for example, when the list screen SCE is in the state illustrated in FIG. 11, if the user wants to cancel the application of the “100-yen discount coupon”, the user taps the button BUI illustrated in FIG. 11. When the user wants to apply the “10% discount coupon”, the user taps the button BUJ illustrated in FIG. 11.

When such an operation is notified to the transaction processing apparatus 1 by the processor 21, the processor 11 makes a determination of YES in ACT 33 in FIG. 4, then makes a determination of YES in ACT 34 indicating that a change was designated, and proceeds to ACT 36.

As ACT 36, the processor 11 checks whether application of an applicable coupon is designated. When it is notified that the button BUJ is tapped, the processor 11 makes a determination of YES indicating that coupon application is designated, and proceeds to ACT 37.

As ACT 37, the processor 11 checks whether it is now necessary to remove (disapply) a previously applied coupon due to application of a newly designated applicable coupon. For example, the processor 11 checks whether there is a coupon, among coupons already set as applied coupons, whose application needs to be removed in response to the application of the designated applicable coupon. For example, in a case where the user possesses both the “100-yen discount coupon” and the “5% discount coupon” that relate to the same commodity as an application condition, and the use conditions (or policy) prevent the “100-yen discount coupon” and the “5% discount coupon” being used in combination, if the “5% discount coupon” is to be applied then the “100-yen discount coupon” cannot be an applied coupon, and it is necessary to remove the “100-yen discount coupon” from the applied coupons. When it is necessary to remove an applied coupon, the processor 11 makes a determination of YES and proceeds to ACT 38.

As ACT 38, the processor 11 instructs the user terminal 2 to display a first change screen.

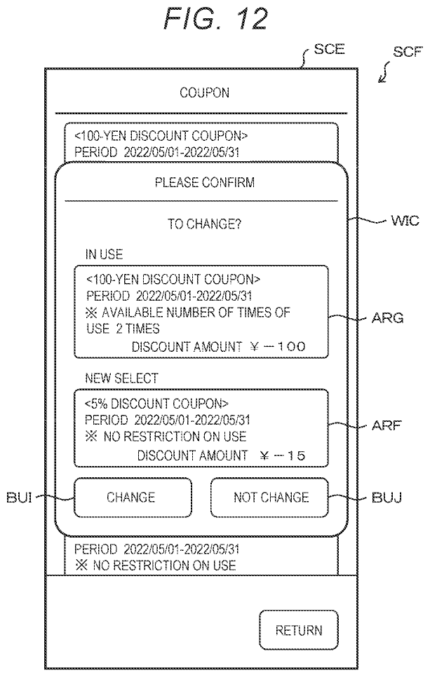

FIG. 12 is a diagram illustrating an example of a first change screen SCF.

The first change screen SCF is a screen showing a window WIC superimposed on the list screen SCE that is displayed immediately before on the user terminal 2.

The window WIC displays, by using a character string in a display area ARF, information for allowing the user to recognize what kind of coupon the applicable coupon is whose application is newly designated. The window WIC displays, by using a character string in a display area ARG, information for allowing the user to recognize what kind of coupon is not to be applied due to application of the designated coupon.

In the window WIC, buttons BUI and BUJ are displayed. The button BUI is a soft key for receiving designation to change a coupon. The button BUJ is a soft key for receiving a designation not to change the coupon.

The user confirms, based on the first change screen SCF, contents of the coupon to be newly applied and contents of the coupon to be removed due to the application of the new coupon, determines whether to change the coupon to be applied, and designates, by a predetermined operation such as tapping one of the buttons BUI and BUJ, whether to make a change.

In the transaction processing apparatus 1, when the instruction to display the first change screen is completed as ACT 38 in FIG. 4, the processor 11 proceeds to ACT 39.

As ACT 39, the processor 11 checks whether a change was designated. Then, after the processor 21 notifies the transaction processing apparatus 1 of the input operation performed to designate a change, the processor 11 makes a determination of YES and proceeds to ACT 40.

As ACT 40, the processor updates the applied coupon according to the designation. For example, the processor 11 sets the designated applicable coupon as an applied coupon, and removes any previous applied coupon that has been determined as necessary to be removed from the applicable coupons in ACT 37. Then, the processor 11 returns to ACT 1 in FIG. 2, and causes the user terminal 2 to display the registration screen SCA that has been updated to reflect an update of the applied coupon(s). Thus, when the processor 11 executes the information processing based on the transaction processing program PRA, the processor 11 functions as a first change unit.

When the processor 21 notifies the transaction processing apparatus 1 of an input operation performed to designate no change (not to make a change), the processor 11 makes a determination of NO in ACT 39 in FIG. 4, and returns to ACT 1 in FIG. 2 without performing ACT 40. In this case, in ACT 1, the processor 11 causes the user terminal 2 to display again the registration screen displayed before the list screen.

When removal of a previously applied coupon due to the application of the newly designated applicable coupon is not necessary, the processor 11 makes a determination of NO in ACT 37 in FIG. 4 and proceeds to ACT 41. As ACT 41, the processor 11 sets the designated applicable coupon as another applied coupon.

As ACT 42, the processor 11 instructs the user terminal 2 to display a second change screen.

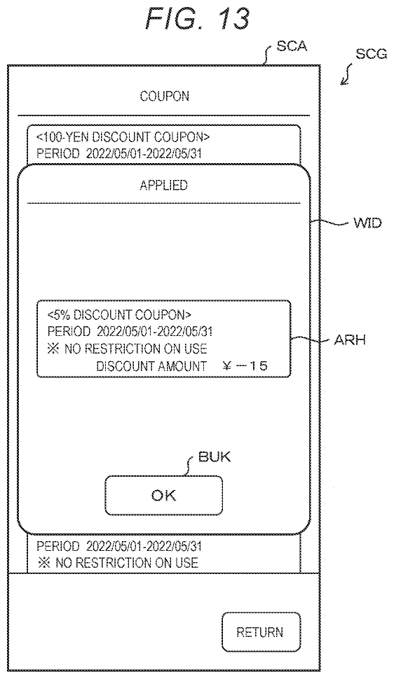

FIG. 13 is a diagram illustrating an example of a second change screen SCG.

The second change screen SCG is a screen showing a window WID superimposed on the list screen SCE displayed immediately before on the user terminal 2. The window WID displays, by using a character string in a display area ARH, information for allowing the user to recognize what kind of coupon the applicable coupon is whose application is newly designated. In the window WID, a button BUK is displayed. The button BUK is a soft key for the user to declare that the coupon displayed in the display area ARH is set as an applied coupon.

The user confirms the second change screen SCG, and then declares the confirmation by a predetermined operation such as tapping the button BUK.

When the processor 11 is notified by the user terminal 2 that the button BUI on the list screen SCE is tapped by the user, the processor 11 makes a determination of NO in ACT 36 in FIG. 4 indicating that the application is not designated, and proceeds to ACT 43.

As ACT 43, the processor 11 excludes the designated applicable coupon from the applied coupon. For example, the processor 11 deletes a coupon identifier for identifying the coupon from the transaction data.

As ACT 44, the processor 11 instructs the user terminal 2 to display a third change screen. The third change screen is, for example, a screen having a layout similar to that of the second change screen SCG, and is a screen that is partially changed so as to allow the user to recognize that a coupon is not applied.

After confirming the third change screen, the user declares the confirmation by a predetermined operation such as tapping a button equivalent to the button BUK.

In the transaction processing apparatus 1, when the instruction to display the second change screen SCG is completed as ACT 42 in FIG. 4 or when the instruction to display the third change screen is completed as ACT 44 in FIG. 4, the processor 11 proceeds to ACT 45 all the same.

As ACT 45, the processor 11 waits for a confirmation operation to be performed. When the processor 11 is notified by the user terminal 2 that an operation of declaring the confirmation has been performed, the processor 11 makes a determination of YES. In this case, the processor 11 returns to ACT 1 in FIG. 2 and causes the user terminal 2 to display the registration screen SCA that is updated to reflect a change result of the applied coupon.

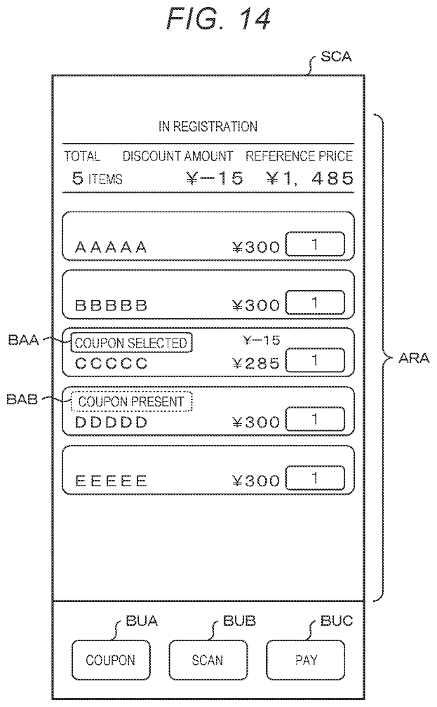

FIG. 14 is a diagram illustrating an example of the registration screen SCA.

The registration screen SCA illustrated in FIG. 14 corresponds to the registration screen SCA illustrated in FIG. 10 but an applied coupon related to the commodity name of “CCCCC” is changed from the “100-yen discount coupon” to the “5% discount coupon”, and thereafter the processor 11 executes ACT 1 in FIG. 2. Therefore, in the image displayed in the display area ARA, a discount amount and a price related to the commodity name of “CCCCC” are changed to −15 yen and 285 yen and the total number of items, the total discount amount and the reference price are updated to 5 items, −15 yen, and 1485 yen accordingly.

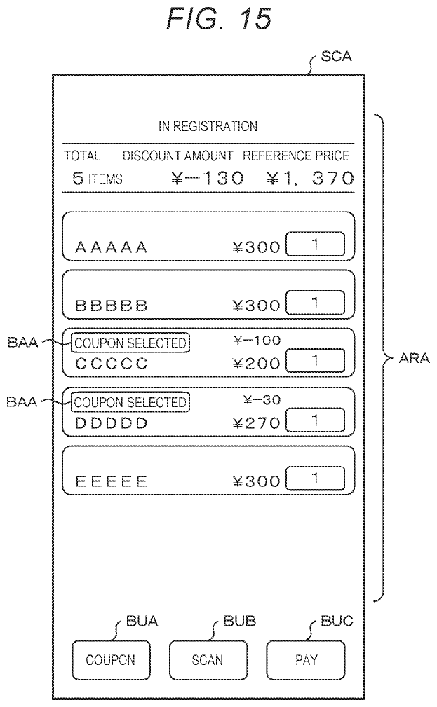

FIG. 15 is a diagram illustrating an example of the registration screen SCA.

The registration screen SCA illustrated in FIG. 15 corresponds to the registration screen SCA illustrated in FIG. 10 but a “10% discount coupon” related to the commodity name of “DDDDD” is added to the applied coupons, and thereafter the processor 11 executes ACT 1 in FIG. 2. Therefore, in the image displayed in the display area ARA, a discount amount and a price related to the commodity name of “DDDDD” are changed to −30 yen and 270 yen, and the total number of items, the total discount amount and the reference price are updated to 5 items, −130 yen, and 1370 yen accordingly. The coupon badge BAB displayed in association with the commodity name of “DDDDD” is replaced with the coupon badge BAA.

When the user wants to change settings related to coupon application related to any one of the commodities already registered as a transaction commodity, the user can tap any one of the coupon badges BAA and BAB displayed in association with the transaction commodity. In response to such an operation, the processor 21 notifies the transaction processing apparatus 1 that the coupon badge BAA or BAB has been designated (user selected). The processor 21 incorporates the commodity code of the commodity associated with the tapped coupon badge BAA or BAB in the notification data.

When the transaction processing apparatus 1 receives the notification, the processor 11 is in the waiting state of ACT 2 in FIG. 2. Then, the processor 11 makes a determination of YES in ACT 2, a determination of NO in ACT 3, a determination of NO in ACT 4, and a determination of YES in ACT 5, and proceeds to ACT 6.

As ACT 6, the processor 11 selects, as the target coupons, all coupons with application conditions related to the notified commodity code from the coupons owned by the user of the user terminal 2. Thereafter, the processor 11 proceeds to ACT 20 in FIG. 3. Then, the processor 11 executes the processing following ACT 20 in the same manner as described above. That is, in ACT 20, the processor 11 instructs the user terminal 2 to display the first change screen SCF including the window WIC in which one or a plurality of display areas are displayed side by side. In the one or more display areas, information for causing the user to recognize what kind of coupon the one or a plurality of target coupons selected in ACT 6 are is shown using character strings. Thus, on the first change screen SCF displayed on the user terminal 2 in response to this instruction, a list of coupons, which are obtained by narrowing down and are related to the commodity associated with the tapped coupon badge BAA or BAB, are displayed. Further, when ACT 22 is executed following ACT 21, the applied coupon is changed. Thus, when the processor 11 executes the information processing based on the transaction processing program PRA, the processor 11 functions as a second narrowing-down unit, a third display unit, and a second change unit.

With the transaction processing system 100, the following various effects are achieved.

Based on the first notification screen SCC, the user can easily recognize that there is a coupon that can be used due to addition of a new transaction commodity. Then, the user can easily designate, by an operation related to the first notification screen SCC, whether to use the coupon. Thus, the user can easily use the coupon.

Based on the first notification screen SCC, the user can easily recognize that there is a plurality of coupons that can be used after a new transaction commodity is added. When the user intends to use any of the coupons, the user can easily designate, by an operation related to the first notification screen SCC, a particular coupon to be used. When the first notification screen SCC showing a plurality of coupons is displayed, as an initial state, a coupon with the largest discount amount among the coupons may be selected as the candidate coupon to be used. Therefore, when the user determines to use a coupon, the user does not necessarily need to perform an operation of designating one particular one of the available coupons, but rather the coupon with the largest discount may be automatically selected/applied.

Based on the second notification screen SCD, the user can easily recognize that a coupon, which can be used due to the addition of a new transaction commodity, has been automatically applied.

By designating the display of the list, the user can change whether or not to apply a coupon by designation related to the first notification screen SCC, based on the list screen SCE displaying only coupons that are obtained by narrowing down and that can be used in view of the current registration state of the transaction commodity.

By tapping the coupon badge BAA or BAB associated with one of the transaction commodities, the user can change the application/non-application of the coupon set by the designation related to the first notification screen SCC, based on the list screen SCE displaying coupons that can be used on condition that the one transaction commodity is included and that are obtained by narrowing down.

The described embodiments can be modified in various ways as follows.

When all coupons are targets of a manual application and the processor 11 makes a determination of YES in ACT 18 in FIG. 3, the processor 11 may proceed to ACT 20 and need not perform ACT 19, ACT 23, or ACT 24.

A part of the processing executed by the processor 11 of the transaction processing apparatus 1 may be executed by the processor 21 of the user terminal 2. For example, the transaction data may be stored in the main memory 22 or the auxiliary storage unit 23, and the processor 21 may itself update the transaction data. In this case, the registration unit would be implemented by information processing by the processor 21.

Some or all of the functions implemented by the processor 11 by the information processing may also or instead be implemented by hardware, such as a logic circuit, that executes information processing that is not based on a software program. The above-described functions may also be implemented by combining software control with the hardware such as a dedicated logic circuit or the like.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A transaction processing system for retail stores, the system comprising:
a communication network;
a transaction processing server connectable to a mobile user terminal via the communication network and including a processor configured to:
receive commodity identifying information from the mobile user terminal for a commodity being registered by a customer in a customer transaction using the mobile user terminal;
register the commodity corresponding to the received commodity identifying information in the customer transaction;
identify an applicable coupon associated with the registered commodity from coupons associated with the customer in a customer database;
cause the mobile user terminal to display a notification screen for notifying the customer of an identified applicable coupon after the applicable coupon is identified; and
receive a response from the mobile user terminal designating the identified applicable coupon for use in the customer transaction.

2. The transaction processing system according to claim 1, wherein, if more than one applicable coupon is associated with the registered commodity in the coupons associated with the customer in the customer database, the notification screen notifies the customer of each of the applicable coupons.

3. The transaction processing system according to claim 1, wherein, if more than one applicable coupon is associated with the registered commodity in the coupons associated with the customer in the customer database, the processor is configured to set one of the applicable coupons as a selected coupon to be applied in the customer transaction on the notification screen.

4. The transaction processing system according to claim 3, wherein the notification screen permits the customer to change the selected coupon to be applied in the customer transaction.

5. The transaction processing system according to claim 1, wherein
the transaction processing server includes a coupon database storing use conditions for a plurality of coupons, and
the processor is further configured to identify any coupon associated with the customer in the customer database having use conditions met by registered commodities in the customer transaction and cause a list of the identified coupons to be displayed on the mobile customer terminal.

6. The transaction processing system according to claim 5, wherein the notification screen permits the customer to select the applicable coupon from the list.

7. The transaction processing system according to claim 1, wherein the processor is further configured to cause the mobile customer terminal to display a list of commodities registered in the customer transaction and a coupon badge adjacent to an entry on the list that is associated with the applicable coupon.

8. The transaction processing system according to claim 1, wherein the mobile customer terminal is a smartphone.

9. The transaction processing system according to claim 1, wherein the mobile customer terminal is a cart-based point-of-sale (POS) terminal.

10. A transaction processing apparatus for transaction processing systems in a retail store, the apparatus comprising:
a communication interface connectable to a communication network; and
a processor configured to:
receive, via the communication interface, commodity identifying information from a mobile user terminal for a commodity being registered by a customer in a customer transaction using the mobile user terminal;
register the commodity corresponding to the received commodity identifying information in the customer transaction;
identify an applicable coupon associated with the registered commodity from coupons associated with the customer in a customer database;
cause the mobile user terminal to display a notification screen for notifying the customer of an identified applicable coupon after the applicable coupon is identified; and
receive a response, via the communication interface, from the mobile user terminal designating the identified applicable coupon for use in the customer transaction.

11. The transaction processing apparatus according to claim 10, wherein, if more than one applicable coupon is associated with the registered commodity in the coupons associated with the customer in the customer database, the notification screen notifies the customer of each of the applicable coupons.

12. The transaction processing apparatus according to claim 10, wherein, if more than one applicable coupon is associated with the registered commodity in the coupons associated with the customer in the customer database, the processor is configured to set one of the applicable coupons as a selected coupon to be applied in the customer transaction on the notification screen.

13. The transaction processing apparatus according to claim 12, wherein the notification screen permits the customer to change the selected coupon to be applied in the customer transaction.

14. The transaction processing apparatus according to claim 10, further comprising:
a coupon database storing use conditions for a plurality of coupons, wherein
the processor is further configured to identify any coupon associated with the customer in the customer database having use conditions met by registered commodities in the customer transaction and cause a list of the identified coupons to be displayed on the mobile customer terminal.

15. The transaction processing apparatus according to claim 14, wherein the notification screen permits the customer to select the applicable coupon from the list.

16. The transaction processing apparatus according to claim 10, wherein the processor is further configured to cause the mobile customer terminal to display a list of commodities registered in the customer transaction and a coupon badge adjacent to an entry on the list that is associated with the applicable coupon.

17. A non-transitory, computer-readable medium storing program instructions which when executed by a transaction processing apparatus causes the apparatus to perform a method comprising:
receiving commodity identifying information from a mobile user terminal for a commodity being registered by a customer in a customer transaction using the mobile user terminal;
registering the commodity corresponding to the received commodity identifying information in the customer transaction;
identifying an applicable coupon associated with the registered commodity from coupons associated with the customer in a customer database;
causing the mobile user terminal to display a notification screen for notifying the customer of an identified applicable coupon after the applicable coupon is identified; and
receiving a response from the mobile user terminal designating the identified applicable coupon for use in the customer transaction.

18. The non-transitory, computer-readable medium according to claim 17, wherein, if more than one applicable coupon is associated with the registered commodity in the coupons associated with the customer in the customer database, the notification screen notifies the customer of each of the applicable coupons.

19. The non-transitory, computer-readable medium according to claim 18, the method further comprising:
setting one of the applicable coupons as a selected coupon to be applied in the customer transaction on the notification screen.
